(19) United States
(12) Patent Application Publication
(10) Pub. No.: US 2004/0117271 A1
(43) Pub. Date: Jun. 17, 2004

(54) Systems and methods for providing catalog configuration

(75) Inventors: Kenneth J. Knight, Kirkland, WA (US); Ritu Manocha, Sammamish, WA (US)

Correspondence Address: WOODCOCK WASHBURN LLP, ONE LIBERTY PLACE, 46TH FLOOR, 1650 MARKET STREET, PHILADELPHIA, PA, 19103, US

(73) Assignee: Microsoft Corporation

(21) Appl. No.: 10/317,382

(22) Filed: Dec. 11, 2002

(51) Int. Cl. G06F 17/60

(52) U.S. Cl. 705/27

(57) ABSTRACT

Described are product or catalog configuration systems and methods for allowing only valid combinations of attributes to be selected. The invention receives as an input a record set of all the product variants for a given product. Then, dropdowns, or other input portions, for each distinct value per variant dimension are exposed. As the user interacts with the configurator by selecting a variant value, the product record set is filtered by the selections made and the remaining variants are repopulated with only the valid choices for the given variant selections made.

### COPYRIGHT NOTICE AND PERMISSION

A portion of the disclosure of this patent document may contain material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice shall apply to this document: Copyright® 2002, Microsoft Corp.

### FIELD OF THE INVENTION

The present invention is directed to systems and methods for providing catalog configuration in a computing system. More specifically, the present invention is directed to providing a valid set of choices from a greater body of information, such as a complete set of products offered, based upon one or more selection criteria.

### BACKGROUND

With the advent of Internet and e-commerce, users have become empowered with the ability to search for, and shop for goods and services without geographic and temporal restriction. Users can purchase goods well after the ordinary business hours of stores are closed, and users can purchase such goods from a variety of computing devices, whether wired or wireless. Moreover, users can download catalogs for off-line usage. In short, the number of options a user is presented with in an on-line experience has greatly facilitated the ways in which users can interact with merchants.

In this regard, on-line catalogs typically allow users to select various aspects to narrow or broaden a search for products they want to review or purchase. For example, a catalog may have an “item of clothing” field, a “color” field, a “size” field, and so forth, with various configurators, such as drop down boxes, lists, or other typical input mechanisms. Such configurators allow users to select their choices in an efficient manner. In such a scenario, a user is generally confronted with a wealth of purchasing options, and the user may wish to easily switch between different types of goods simply, and based upon criteria well understood to the user. An exemplary situation found in connection with on-line catalogs today is illustrated in FIGS. 1A to 1C, wherein a user has navigated to a Web site 30 for the perusal of various options relating to automobile purchasing. In FIG. 1A, the user is presented with a number of input search options including input portion 32 for selecting whether the user wishes to search new or used cars, input portions 34a or 34b for selecting a make of a car, an input portion 36a or 36b for selecting a model of the car, input portion 38 for selecting a car category and input portion 39 for inputting the user's zip code. In this exemplary scenario, input portions 36a and 36b are not enabled until a user selects a make of a car via input portions 34a or 34b, or otherwise narrows the model field.

In FIG. 1B, one can see that if a user selects input portion 34b, a configurator portion, such as a drop down list or menu, appears enabling the user to select an automobile make. FIG. 1C illustrates the result of having selected “Honda” from the drop down list. The model input portions 36b is enabled, and only Honda models appear. In this fashion, a user can quickly navigate to a make and model, through eliminating automobiles not meeting any one or more selected criteria. In this case, a user has navigated very quickly and simply to information relating to a Honda S2000, despite the existence of hundreds of vehicles and limited presentation space.

However, while such a model is extremely convenient for a user, the model is presently very inconvenient to the merchant, or more particularly, the developer designing the code for the merchant to perform the above functionality. In this regard, the developer presently “hardwires” the code to eliminate options. In other words, the developer provides static code with built in intelligence that when Honda is selected, only Accord, Civic, CR-V, Insight, Odyssey, Passport, Pilot and S2000 are displayed in the make drop down menu, and thus each time that Honda changes their product line, or more difficultly, each time that any car manufacturer changes a product line, the static code must be updated by the developer, and recompiled. Thus, there is a need for a generalizable mechanism for providing catalog configuration, which does not require recoding and recompilation when a product line changes. Moreover, there is a need for providing a standard way for a developer to provide means for a user to filter through catalog data easily based upon one or more search criteria input by the user.

### SUMMARY OF THE INVENTION

The present invention provides systems and methods for allowing only valid combinations of attributes to be selected in connection with product or catalog configuration. The invention receives as an input a record set of all the product variants for a given product. Then, dropdowns, or other input portions, for each distinct value per variant dimension are exposed. As a user interacts with the configurator by selecting a variant value, the product record set is filtered by the selections made and the remaining variants are repopulated with only the valid choices for the given variant selections made.

Other features and embodiments of the present invention are described below.

### BRIEF DESCRIPTION OF THE DRAWINGS

The systems and methods for providing catalog configuration in accordance with the present invention are further described with reference to the accompanying drawings in which:

FIGS. 1A to 1C illustrate a prior art technique whereby fixed or static code performs product configuration;

FIG. 2A is a block diagram representing an exemplary network environment having a variety of computing devices in which the present invention may be implemented;

FIG. 2B is a block diagram representing an exemplary non-limiting computing device in which the present invention may be implemented;

FIGS. 3A to 3D illustrate exemplary operation of the product configurator of the present invention;

FIG. 4 illustrates exemplary non-limiting data structures for storing product configuration information in accordance with the invention; and

FIGS. 5A and 5B show exemplary non-limiting screen shots illustrating the product configuration control(s) of the invention in operation.

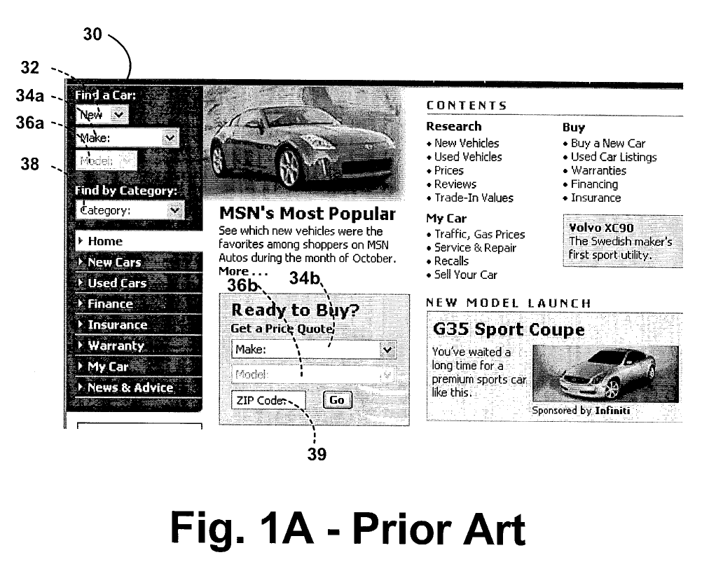

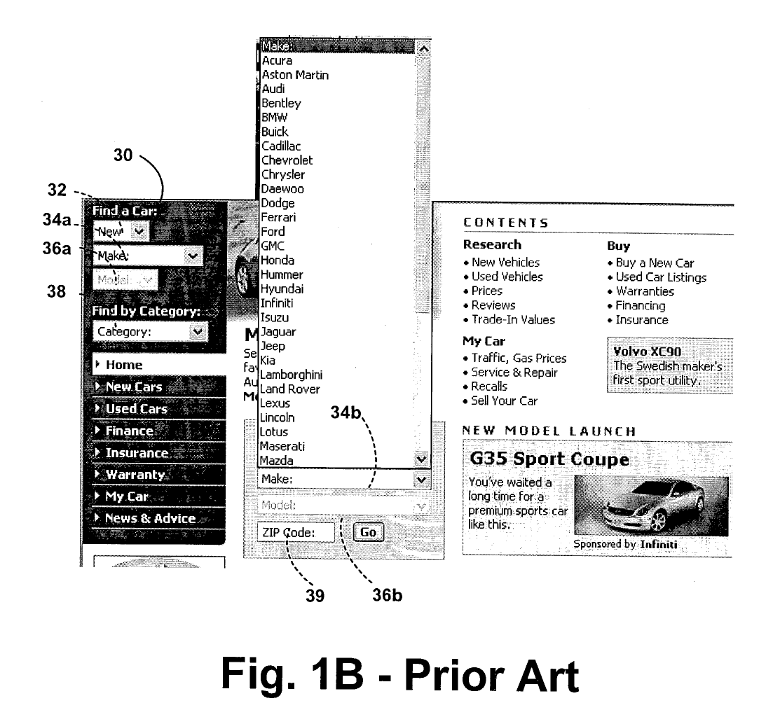

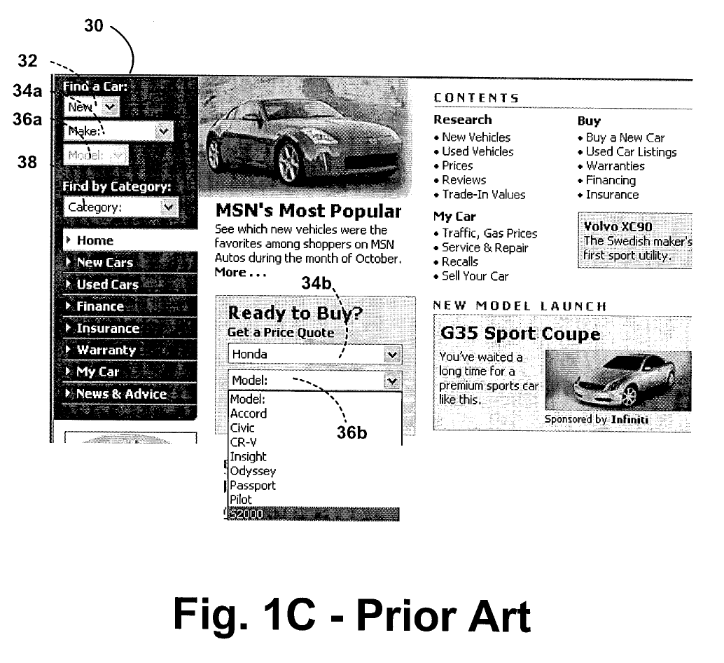

### DETAILED DESCRIPTION OF THE INVENTION

Overview

The invention is directed to a mechanism for allowing only valid combinations of attributes to be selected. The invention takes a record set of all the product variants for a given product. Then it exposes dropdowns for each distinct value per variant dimension. As the user interacts with the configurator by selecting a variant value it then filters the product record set by the selections made and repopulates the remaining variants with only the valid choices for the given variant selections made. In various embodiments, the invention provides a product configurator that allows customers to easily select a valid set of variants in order to correctly identify existing, or offered, combinations for the given product. Thus, if a particular size only comes in a particular color, then once the size is selected, the color is filtered to the valid choice. In this regard, users can make selections in any order.

Exemplary Networked and Distributed Environments

One of ordinary skill in the art can appreciate that a computer or other client or server device can be deployed as part of a computer network, or in a distributed computing environment. In this regard, the present invention pertains to any computer system having any number of memory or storage units, and any number of applications and processes occurring across any number of storage units or volumes, which may be used in connection with product configuration processes. The present invention may apply to an environment with server computers and client computers deployed in a network environment or distributed computing environment, having remote or local storage. The present invention may also be applied to standalone computing devices, having programming language functionality, interpretation and execution capabilities for generating, receiving and transmitting information in connection with remote or local services.

Distributed computing facilitates sharing of computer resources and services by direct exchange between computing devices and systems. These resources and services include the exchange of information, cache storage, and disk storage for files. Distributed computing takes advantage of network connectivity, allowing clients to leverage their collective power to benefit the entire enterprise. In this regard, a variety of devices may have applications, objects or resources that may implicate the product configuration processes of the invention.

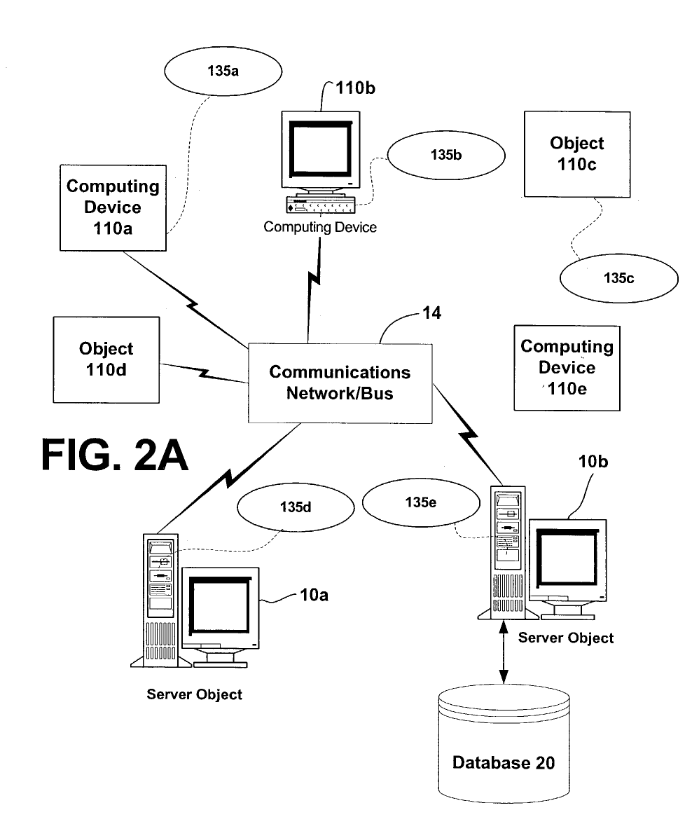

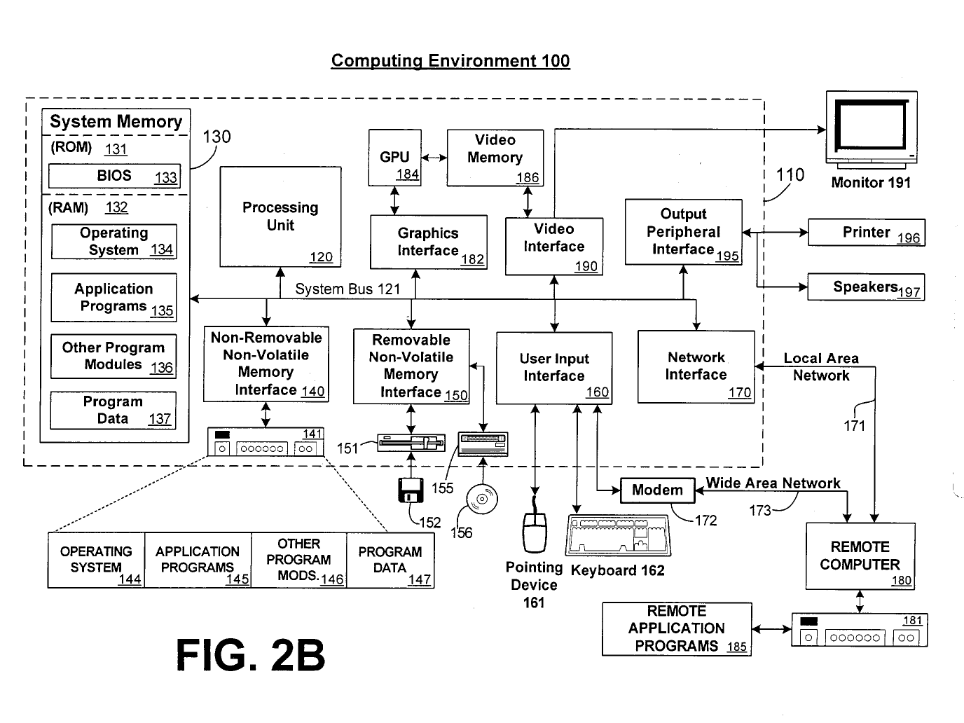

FIG. 2A provides a schematic diagram of an exemplary networked or distributed computing environment. The distributed computing environment comprises computing objects 10a, 10b, etc. and computing objects or devices 110a, 110b, 110c, etc. These objects may comprise programs, methods, data stores, programmable logic, etc. The objects may comprise portions of the same or different devices such as PDAs, televisions, MP3 players, televisions, personal computers, etc. Each object can communicate with another object by way of the communications network 14. This network may itself comprise other computing objects and computing devices that provide services to the system of FIG. 2A. In accordance with an aspect of the invention, each object 10a, 10b, etc. or 110a, 110b, 110c, etc. may contain an application that might make use of an API, or other object, software or hardware, to request use of the product configuration services in accordance with the invention.

In a distributed computing architecture, computers, which may have traditionally been used solely as clients, communicate directly among themselves and can act as both clients and servers, assuming whatever role is most efficient for the network. This reduces the load on servers and allows all of the clients to access resources available on other clients, thereby increasing the capability and efficiency of the entire network. Services that use the product configuration techniques in accordance with the present invention may thus be distributed among clients and servers, acting in a way that is efficient for the entire network.

Distributed computing can help businesses deliver services and capabilities more efficiently across diverse geographic boundaries. Moreover, distributed computing can move data closer to the point where data is consumed acting as a network caching mechanism. Distributed computing also allows computing networks to dynamically work together using intelligent agents. Agents reside on peer computers and communicate various kinds of information back and forth. Agents may also initiate tasks on behalf of other peer systems. For instance, intelligent agents can be used to prioritize tasks on a network, change traffic flow, search for files locally or determine anomalous behavior such as a virus and stop it before it affects the network. All sorts of other services may be contemplated as well. Since data may in practice be physically located in one or more locations, the ability to distribute services that use the product configuration techniques described herein is of great utility in such a system.

It can also be appreciated that an object, such as 110c, may be hosted on another computing device 10a, 10b, etc. or 110a, 110b, etc. Thus, although the physical environment depicted may show the connected devices as computers, such illustration is merely exemplary and the physical environment may alternatively be depicted or described comprising various digital devices such as PDAs, televisions, MP3 players, etc., software objects such as interfaces, COM objects and the like.

There are a variety of systems, components, and network configurations that support distributed computing environments. For example, computing systems may be connected together by wired or wireless systems, by local networks or widely distributed networks. Currently, many of the networks are coupled to the Internet, which provides the infrastructure for widely distributed computing and encompasses many different networks.

In home networking environments, there are at least four disparate network transport media that may each support a unique protocol, such as Power line, data (both wireless and wired), voice (e.g., telephone) and entertainment media. Most home control devices such as light switches and appliances may use power line for connectivity. Data Services may enter the home as broadband (e.g., either DSL or Cable modem) and are accessible within the home using either wireless (e.g., HomeRF or 802.11b) or wired (e.g., Home PNA, Cat 5, even power line) connectivity. Voice traffic may enter the home either as wired (e.g., Cat 3) or wireless (e.g., cell phones) and may be distributed within the home using Cat 3 wiring. Entertainment media, or other graphical data, may enter the home either through satellite or cable and is typically distributed in the home using coaxial cable. IEEE 1394 and DVI are also emerging as digital interconnects for clusters of media devices. All of these network environments and others that may emerge as protocol standards may be interconnected to form an intranet that may be connected to the outside world by way of the Internet. In short, a variety of disparate sources exist for the storage and transmission of data, and consequently, moving forward, computing devices will require ways of sharing data, such as data accessed or utilized incident to program objects, which make use of the product configuration techniques in accordance with the present invention.

The Internet commonly refers to the collection of networks and gateways that utilize the TCP/IP suite of protocols, which are well-known in the art of computer networking. TCP/IP is an acronym for “Transport Control Protocol/Interface Program.” The Internet can be described as a system of geographically distributed remote computer networks interconnected by computers executing networking protocols that allow users to interact and share information over the networks. Because of such wide-spread information sharing, remote networks such as the Internet have thus far generally evolved into an open system for which developers can design software applications for performing specialized operations or services, essentially without restriction.

Thus, the network infrastructure enables a host of network topologies such as client/server, peer-to-peer, or hybrid architectures. The “client” is a member of a class or group that uses the services of another class or group to which it is not related. Thus, in computing, a client is a process, i.e., roughly a set of instructions or tasks, that requests a service provided by another program. The client process utilizes the requested service without having to “know” any working details about the other program or the service itself. In a client/server architecture, particularly a networked system, a client is usually a computer that accesses shared network resources provided by another computer, e.g., a server. In the example of FIG. 2A, computers 110a, 110b, etc. can be thought of as clients and computer 10a, 10b, etc. can be thought of as the server where server 10a, 10b, etc. maintains the data that is then replicated in the client computers 110a, 110b, etc., although any computer could be considered a client, a server, or both, depending on the circumstances.

A server is typically a remote computer system accessible over a remote network such as the Internet. The client process may be active in a first computer system, and the server process may be active in a second computer system, communicating with one another over a communications medium, thus providing distributed functionality and allowing multiple clients to take advantage of the information-gathering capabilities of the server.

Client and server communicate with one another utilizing the functionality provided by a protocol layer. For example, Hypertext-Transfer Protocol (HTTP) is a common protocol that is used in conjunction with the World Wide Web (WWW). Typically, a computer network address such as a Universal Resource Locator (URL) or an Internet Protocol (IP) address is used to identify the server or client computers to each other. The network address can be referred to as a URL address. For example, communication can be provided over a communications medium. In particular, the client and server may be coupled to one another via TCP/IP connections for high-capacity communication.

Thus, FIG. 2A illustrates an exemplary networked or distributed environment, with a server in communication with client computers via a network/bus, in which the present invention may be employed. In more detail, a number of servers 10a, 10b, etc., are interconnected via a communications network/bus 14, which may be a LAN, WAN, intranet, the Internet, etc., with a number of client or remote computing devices 110a, 110b, 110c, 110d, 110e, etc., such as a portable computer, handheld computer, thin client, networked appliance, or other device, such as a VCR, TV, oven, light, heater and the like in accordance with the present invention. It is thus contemplated that the present invention may apply to any computing device in connection with which it is desirable to implement product configuration.

In a network environment in which the communications network/bus 14 is the Internet, for example, the servers 10a, 10b, etc. can be Web servers with which the clients 110a, 110b, 110c, 110d, 110e, etc. communicate via any of a number of known protocols such as HTTP. Servers 10a, 10b, etc. may also serve as clients 110a, 110b, 110c, 110d, 110e, etc., as may be characteristic of a distributed computing environment. Communications may be wired or wireless, where appropriate. Client devices 110a, 110b, 110c, 110d, 110e, etc. may or may not communicate via communications network/bus 14, and may have independent communications associated therewith. For example, in the case of a TV or VCR, there may or may not be a networked aspect to the control thereof. Each client computer 110a, 110b, 110c, 110d, 110e, etc. and server computer 10a, 10b, etc. may be equipped with various application program modules or objects 135 and with connections or access to various types of storage elements or objects, across which files may be stored or to which portion(s) of files may be downloaded or migrated. Any computer 10a, 10b, 110a, 110b, etc. may be responsible for the maintenance and updating of a database 20 or other storage element in accordance with the present invention, such as a database or memory 20 for storing data processed according to the invention. Thus, the present invention can be utilized in a computer network environment having client computers 110a, 110b, etc. that can access and interact with a computer network/bus 14 and server computers 10a, 10b, etc. that may interact with client computers 110a, 110b, etc. and other like devices, and databases 20.

Exemplary Computing Device

FIG. 2B and the following discussion are intended to provide a brief general description of a suitable computing environment in which the invention may be implemented. It should be understood, however, that handheld, portable and other computing devices and computing objects of all kinds are contemplated for use in connection with the present invention. While a general purpose computer is described below, this is but one example, and the present invention may be implemented with a thin client having network/bus interoperability and interaction. Thus, the present invention may be implemented in an environment of networked hosted services in which very little or minimal client resources are implicated, e.g., a networked environment in which the client device serves merely as an interface to the network/bus, such as an object placed in an appliance. In essence, anywhere that data may be stored or from which data may be retrieved is a desirable, or suitable, environment for operation of the techniques for product configuration data in accordance with the invention.

Although not required, the invention can be implemented via an operating system, for use by a developer of services for a device or object, and/or included within application software that operates in connection with product configuration control(s) in accordance with the invention. Software may be described in the general context of computer-executable instructions, such as program modules, being executed by one or more computers, such as client workstations, servers or other devices. Generally, program modules include routines, programs, objects, components, data structures and the like that perform particular tasks or implement particular abstract data types. Typically, the functionality of the program modules may be combined or distributed as desired in various embodiments. Moreover, those skilled in the art will appreciate that the invention may be practiced with other computer system configurations and protocols. Other well known computing systems, environments, and/or configurations that may be suitable for use with the invention include, but are not limited to, personal computers (PCs), automated teller machines, server computers, hand-held or laptop devices, multi-processor systems, microprocessor-based systems, programmable consumer electronics, network PCs, appliances, lights, environmental control elements, minicomputers, mainframe computers and the like. The invention may also be practiced in distributed computing environments where tasks are performed by remote processing devices that are linked through a communications network/bus or other data transmission medium. In a distributed computing environment, program modules may be located in both local and remote computer storage media including memory storage devices, and client nodes may in turn behave as server nodes.

FIG. 2B thus illustrates an example of a suitable computing system environment 100 in which the invention may be implemented, although as made clear above, the computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

With reference to FIG. 2B, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 2B illustrates operating system 134, application programs 135, other program modules 136, and program data 137.

The computer 110 may also include other removable/non-removable, volatile/nonvolatile computer storage media. By way of example only, FIG. 2B illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156, such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 2B provide storage of computer readable instructions, data structures, program modules and other data for the computer 110. In FIG. 2B, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus 121, but may be connected by other interface and bus structures, such as a parallel port, game port or a universal serial bus (USB). A graphics interface 182, such as Northbridge, may also be connected to the system bus 121. Northbridge is a chipset that communicates with the CPU, or host processing unit 120, and assumes responsibility for accelerated graphics port (AGP) communications. One or more graphics processing units (GPUs) 184 may communicate with graphics interface 182. In this regard, GPUs 184 generally include on-chip memory storage, such as register storage and GPUs 184 communicate with a video memory 186, wherein the application variables of the invention may have impact. GPUs 184, however, are but one example of a coprocessor and thus a variety of coprocessing devices may be included in computer 110, and may include a variety of procedural shaders, such as pixel and vertex shaders. A monitor 191 or other type of display device is also connected to the system bus 121 via an interface, such as a video interface 190, which may in turn communicate with video memory 186. In addition to monitor 191, computers may also include other peripheral output devices such as speakers 197 and printer 196, which may be connected through an output peripheral interface 195.

The computer 110 may operate in a networked or distributed environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 2B. The logical connections depicted in FIG. 2B include a local area network (LAN) 171 and a wide area network (WAN) 173, but may also include other networks/buses. Such networking environments are commonplace in homes, offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 2B illustrates remote application programs 185 as residing on memory device 181. It will be appreciated that the network connections shown are exemplary and other means of establishing a communications link between the computers may be used.

Exemplary Distributed Computing Frameworks or Architectures

Various distributed computing frameworks have been and are being developed in light of the convergence of personal computing and the Internet. Individuals and business users alike are provided with a seamlessly interoperable and Web-enabled interface for applications and computing devices, making computing activities increasingly Web browser or network-oriented.

For example, MICROSOFT®'s .NET platform includes servers, building-block services, such as Web-based data storage and downloadable device software. Generally speaking, the .NET platform provides (1) the ability to make the entire range of computing devices work together and to have user information automatically updated and synchronized on all of them, (2) increased interactive capability for Web sites, enabled by greater use of XML rather than HTML, (3) online services that feature customized access and delivery of products and services to the user from a central starting point for the management of various applications, such as e-mail, for example, or software, such as Office .NET, (4) centralized data storage, which will increase efficiency and ease of access to information, as well as synchronization of information among users and devices, (5) the ability to integrate various communications media, such as e-mail, faxes, and telephones, (6) for developers, the ability to create reusable modules, thereby increasing productivity and reducing the number of programming errors and (7) many other cross-platform integration features as well.

While some exemplary embodiments herein are described in connection with software residing on a computing device, one or more portions of the invention may also be implemented via an operating system, application programming interface (API) or a “middle man” object, a control object, hardware, firmware, etc., such that the methods may be included in, supported in or accessed via all of .NET's languages and services, and in other distributed computing frameworks as well.

Systems and Methods for Providing Catalog Configuration

This invention provides systems and methods that enable shoppers to configure valid multi-variant products by continuously adapting the remaining unpopulated variant drop downs.

The catalog configuration tool enables companies with catalogs to provide product configuration simply by dragging and dropping a control provided by the present invention onto their product pages, thereby saving time by eliminating the writing of custom configurators, and enabling companies to get their catalogs up and running on their e-commerce site quickly and easily.

In one embodiment, the catalog configurator is designed to work with a greater set of tools and components that can be used in connection with a commerce server catalog computing system. However, the invention is not limited thereto, and accordingly, the invention applies to any catalog computing system. In exemplary embodiments, the invention receives as input a record set of all the product variants for a given product. Then, dropdowns are exposed for each distinct value per variant dimension. As the user interacts with the configurator by selecting a variant value, the product record set is filtered according to the selections made and the remaining variants are repopulated with only the valid choices for the given variant selections made. In this way, the product configurator of the invention allows customers to easily select a valid set of variants in order to correctly identify valid choice(s) for the given product.

In an exemplary non-limiting embodiment, the invention is implemented as a .NET control, which handles the display and selection of variant properties for a commerce server catalog that includes product with variant dimensions. The control can be included in the ProductDetails.aspx page, whereby the control is visible only for products with variants. Initially, all distinct values for each variant property are shown in the variant dropdowns. A user can select a particular combination by starting the selection with any variant property. The following data in Table I serves to illustrate exemplary operation of the invention:

TABLE I

| Size | Color | Cuff |
|---|---|---|
| Small | Red | Hemmed |
| Medium | Red | Cuffed |
| Medium | Blue | Cuffed |
| Large | Blue | Cuffed |

In accordance with the invention, one can see that with the four available products, with three variables (size, color and cuff), if the user selects small for size, then since there is only one color red in small, the color drop down changes to list only red, which then becomes the selection for the color dropdown. Similarly, since there is only the hemmed cuff in small and red, the cuff drop down changes to list only hemmed, which also becomes the selection, and the product identified by these three values is the selected product, merely through the selection of the size dropdown. Once can see that a similar result would occur if a user selected hemmed from the cuff dropdown.

In one embodiment, the invention provides a “Reset Variant Data” input portion, e.g., button, on the page that allows users to reset all the variant information to the state wherein all values are shown for all properties, but no value is selected.

If after just navigating to a product page or inputting reset, the user starts from the second property and chooses color to be red, then the size drop down lists small and medium as the available choices, since those are the sizes available for color being red, but none of these sizes are selected. Similarly, the cuff dropdown lists hemmed and cuffed. If the user then chooses size to be small, then hemmed is automatically selected for cuff. Hemmed is also the only value in the cuff drop down since only hemmed is available in small and red.

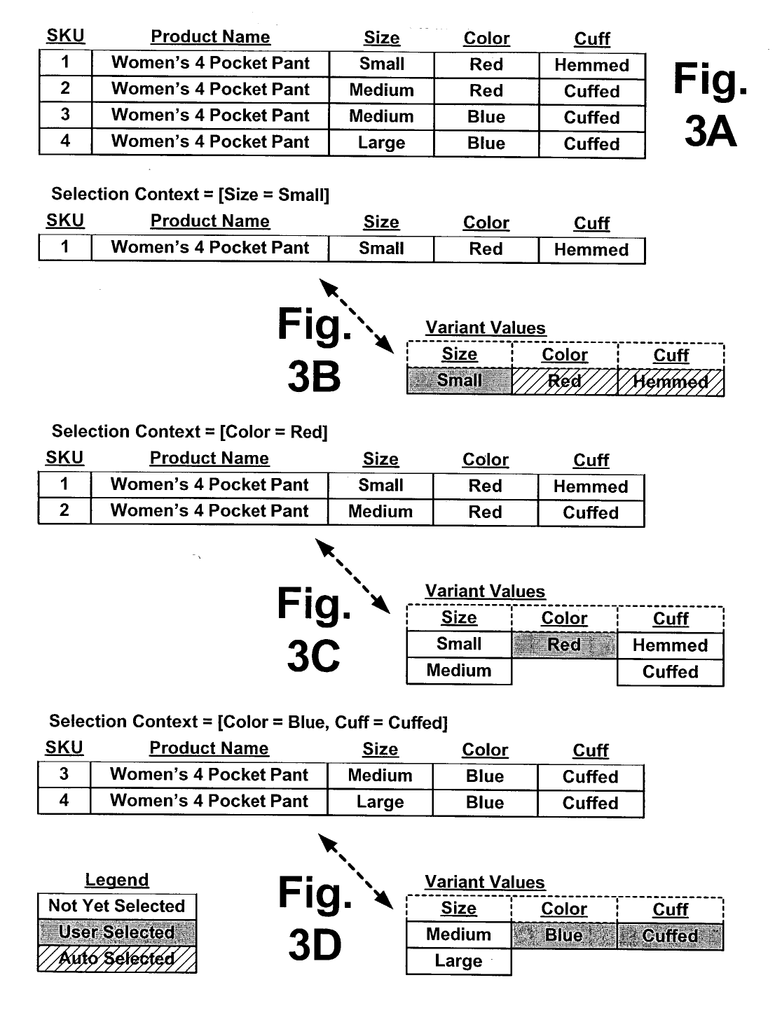

Users may choose any variant at any time. For illustrative purposes, FIG. 3A shows an initial dataset and FIGS. 3B to 3D show how that dataset is filtered to a result set for subsequent choices and corresponding effect on drop down lists. FIG. 3B shows filtering results for a selection context wherein size is selected to be small. FIG. 3C shows filtering results for a selection context wherein color is selected to be red. FIG. 3D shows filtering results for a selection context wherein color is selected to be blue and cuff is selected to be cuffed. One can see that based on certain choices to one variant, others may be automatically selected. For instance, in FIG. 3B, the user has merely selected small from the size input portion, however, since for small size, only red and hemmed options are available for color and cuff, respectively, the color and cuff input portions are automatically populated.

In order to help site builders manage product families, the invention provides configuration on product view pages via a product variant control. In further embodiments, if a user selects a product, which is actually part of a product family, i.e., implicates product variants, then all the variant drop downs are automatically populated to correspond to the selected product. In this regard, the catalog control has knowledge for a given product family, which dimensions are variants and which are not. By doing a select distinct on all of the product variants of a product family, for each distinct column, it can be observed what the values are to populate each of the dimensions.

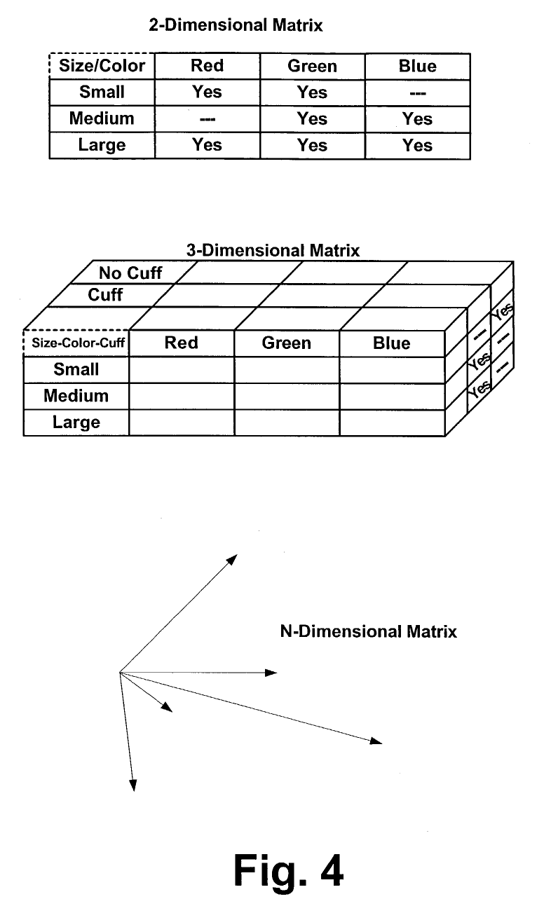

In exemplary non-limiting embodiments, product variants can be represented via N-dimensional matrices, wherein N represents the number of distinct kinds of variants, e.g., size, color, cuff, etc. FIG. 4 illustrates this concept in two dimensions (a 2×3 matrix) and three dimensions (a 2×3×3 matrix), since these can be spatially represented for clarity, but the invention contemplates any number of dimensions, and any number of variants. Such information lends itself to storage in a relational database, although any storage technique is contemplated. For a typical commercial good, such as a shirt, no more than six variants are generally required, although a large number of variants might be desirable for a very complex commercial good, e.g., an airplane or a boat.

In this regard, the two-dimensional matrix of FIG. 4 shows that if a user selects the color red or blue, the size drop down is populated with only two of the three size options. This can be done based on the result set of the product family. As the user makes variant selections, the other variant drop downs are repopulated with the appropriate remaining options.

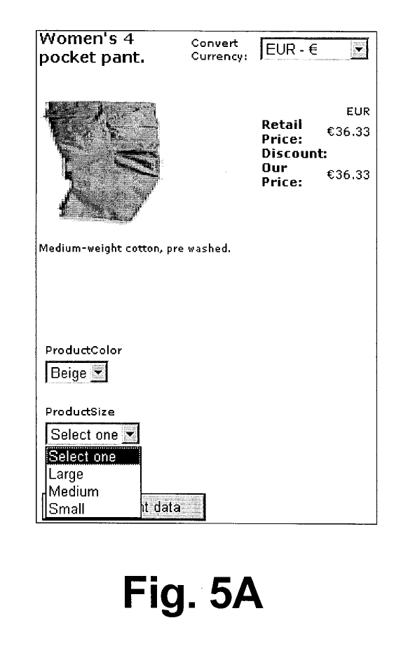

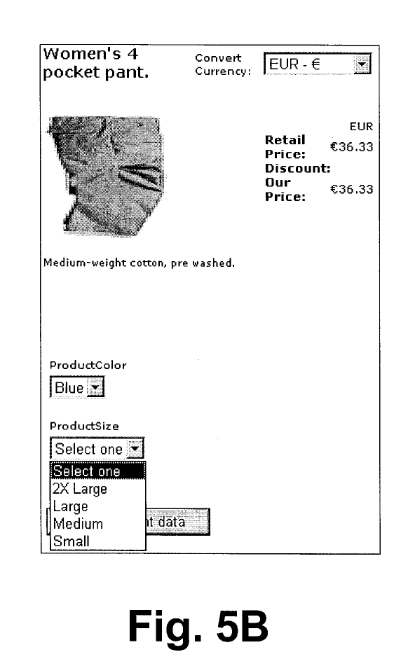

FIGS. 5A and 5B illustrate exemplary screen shots showing the product configurator of the invention in operation. In the example of FIG. 5A, a customer has selected color to be Beige, which then causes only the stock keeping units (SKUs) that have color equal to beige to be selected. Then, only the valid product sizes for color equal to beige are shown, namely Small, Medium and Large (not X-Large, or XX-large). In the example of FIG. 5B, one can see that selecting color equal to blue shows a greater selection of size (includes XX-Large).

The systems and methods described herein, and corresponding control(s) can be utilized in connection with any dataset approach for managing a set of records that include all the valid SKUs with each of their variant values. From such a dataset, one can use the same algorithmic approaches variously outlined above to select distinct variant values from the continuously filtered dataset.

There are multiple ways of implementing the present invention, e.g., an appropriate API, tool kit, driver code, operating system, control, standalone or downloadable software object, etc. which enables applications and services to use the product configuration methods of the invention. The invention contemplates the use of the invention from the standpoint of an API (or other software object), as well as from a software or hardware object that communicates in connection with product configuration data. Thus, various implementations of the invention described herein may have aspects that are wholly in hardware, partly in hardware and partly in software, as well as in software.

As mentioned above, while exemplary embodiments of the present invention have been described in connection with various computing devices and network architectures, the underlying concepts may be applied to any computing device or system in which it is desirable to implement product configuration. Thus, the techniques for encoding/decoding data in accordance with the present invention may be applied to a variety of applications and devices. For instance, the algorithm(s) and hardware implementations of the invention may be applied to the operating system of a computing device, provided as a separate object on the device, as part of another object, as a reusable control, as a downloadable object from a server, as a “middle man” between a device or object and the network, as a distributed object, as hardware, in memory, a combination of any of the foregoing, etc. While exemplary programming languages, names and examples are chosen herein as representative of various choices, these languages, names and examples are not intended to be limiting. With respect to embodiments referring to the use of a control for achieving the invention, the invention is not limited to the provision of a .NET control, but rather should be thought of in the broader context of any piece of software (and/ore hardware) that achieves the configuration objectives in accordance with the invention. One of ordinary skill in the art will appreciate that there are numerous ways of providing object code and nomenclature that achieves the same, similar or equivalent functionality achieved by the various embodiments of the invention. The term “product” as utilized herein refers to products and/or services, and/or anything else that can be offered for sale via an Internet catalog. The invention may be implemented in connection with an on-line auction or bidding site as well.

As mentioned, the various techniques described herein may be implemented in connection with hardware or software or, where appropriate, with a combination of both. Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computing device will generally include a processor, a storage medium readable by the processor (including volatile and non-volatile memory and/or storage elements), at least one input device, and at least one output device. One or more programs that may utilize the product configuration techniques of the present invention, e.g., through the use of a data processing API, reusable controls, or the like, are preferably implemented in a high level procedural or object oriented programming language to communicate with a computer system. However, the program(s) can be implemented in assembly or machine language, if desired. In any case, the language may be a compiled or interpreted language, and combined with hardware implementations.

The methods and apparatus of the present invention may also be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, a video recorder or the like, or a receiving machine having the signal processing capabilities as described in exemplary embodiments above becomes an apparatus for practicing the invention. When implemented on a general-purpose processor, the program code combines with the processor to provide a unique apparatus that operates to invoke the functionality of the present invention. Additionally, any storage techniques used in connection with the present invention may invariably be a combination of hardware and software.

While the present invention has been described in connection with the preferred embodiments of the various figures, it is to be understood that other similar embodiments may be used or modifications and additions may be made to the described embodiment for performing the same function of the present invention without deviating therefrom. For example, while exemplary network environments of the invention are described in the context of a networked environment, such as a peer to peer networked environment, one skilled in the art will recognize that the present invention is not limited thereto, and that the methods, as described in the present application may apply to any computing device or environment, such as a gaming console, handheld computer, portable computer, etc., whether wired or wireless, and may be applied to any number of such computing devices connected via a communications network, and interacting across the network. Furthermore, it should be emphasized that a variety of computer platforms, including handheld device operating systems and other application specific operating systems are contemplated, especially as the number of wireless networked devices continues to proliferate. Still further, the present invention may be implemented in or across a plurality of processing chips or devices, and storage may similarly be effected across a plurality of devices. Therefore, the present invention should not be limited to any single embodiment, but rather should be construed in breadth and scope in accordance with the appended claims.

What is claimed is:

1. A method for automatically configuring products via a reusable control in connection with an interactive display in a computing system, the method comprising:
specifying a collection of products;
specifying a plurality of variant dimensions for the collection of products;
specifying a list of valid product configurations for the collection of products;
maintaining at least one selection criterion corresponding to at least one chosen variant dimension's value; and
automatically populating the remaining variant dimensions with valid distinct values based on said at least one selection criterion.

2. A method according to claim 1, further including receiving input at a reset variant data input portion, whereby all the variant information is reset to the state wherein all values are shown for all variant dimensions, but no values are selected.

3. A method according to claim 2, wherein all the variant information is reset to the state wherein all values are shown for all variant dimensions, but no values are selected, except for variant dimensions having only one valid value, wherein the one valid value is shown for those exceptions.

4. A method according to claim 1, further including, if a user selects a product that is part of a product family, automatically populating all variant drop downs to correspond to the selected product.

5. A method according to claim 4, wherein for a given product family, the control has knowledge of which dimensions are variants and which are not.

6. At least one of an operating system, driver code, an application programming interface, a tool kit and a processing device for performing the method of configuring via the control of claim 1.

7. A modulated data signal carrying computer executable instructions for performing the method of claim 1.

8. A computer readable medium comprising computer executable instructions for performing the method of claim 1.

9. A computer readable medium bearing computer executable instructions for performing a product configuration process, the process comprising:
specifying a product collection, the variant dimensions of the product collection and a plurality of valid product configurations for the product collection;
maintaining a selection criterion of a chosen variant dimension's value; and
automatically populating the remaining variant dimensions with valid distinct values based on the current selection criterion.

10. A computer readable medium according to claim 9, further including receiving input at a reset variant data input portion, whereby all the variant information is reset to the state wherein all values are shown for all properties, but no values are selected

11. A computer readable medium according to claim 10, further including receiving input at a reset variant data input portion, whereby all the variant information is reset to the state wherein all values are shown for all variant dimensions, but no values are selected, except for variant dimensions having only one valid value, wherein the one valid value is shown for those exceptions.

12. A computer readable medium according to claim 9, further including, if a user selects a product that has variants, automatically populating all the variant drop downs to correspond to the selected product variant distinct value choices.

13. A computer readable medium according to claim 12, wherein for a given product family, the control has knowledge of which dimensions are variants and which are not.

14. A computing system for use in connection with product configuration, comprising:
a display device;
at least one input device;
a processing unit;
at least one storage unit comprising information relating to a collection of products, a plurality of variant dimensions for the collection of products and a list of valid product configurations for the collection of products;
wherein in response to receiving a selection via the at least one input device for at least one variant dimension value, at least one selection criterion is maintained, and wherein said processing unit automatically populates and displays on the display device the remaining variant dimensions with valid distinct values based on the current at least one selection criterion.

15. A system according to claim 14, wherein a user inputs data in a reset variant data input portion, whereby all the variant information is reset to the state wherein all values are shown for all properties, but no values are selected.

16. A system according to claim 15, wherein a user inputs data in a reset variant data input portion, whereby all the variant information is reset to the state wherein all values are shown for all properties, but no values are selected, except for variant dimensions having only one valid value, wherein the one valid value is shown for those exceptions.

17. A system according to claim 14, wherein if a user selects a product that is part of a product family, all the variant drop downs are automatically populated to correspond to the selected product.

18. A system according to claim 17, wherein for a given product family, knowledge of which dimensions are variants and which are not is maintained.

19. A method for providing a valid set of choices from a greater body of information based upon one or more selection criteria via a reusable control, comprising:
exposing a plurality of input portions, an input portion for each distinct value per variant dimension for a record set of all product variants;
receiving a selection of a variant value at an input portion;
filtering the record set based upon the selection; and
based on the filtering, automatically repopulating the remaining input portions with only the valid choices for the selection.

20. A method according to claim 19, further including receiving input at a reset variant data input portion, whereby all the variant information is reset to the state wherein all values are shown for all properties, but no values are selected.

21. A method according to claim 20, wherein all the variant information is reset to the state wherein all values are shown for all variant dimensions, but no values are selected, except for variant dimensions having only one valid value, wherein the one valid value is shown for those exceptions.

22. A method according to claim 19, further including, if a user selects a product that is part of a product family, automatically populating all the variant drop downs to correspond to the selected product.

23. A method according to claim 22, wherein for a given product family, the control has knowledge of which dimensions are variants and which are not.

24. At least one of an operating system, driver code, an application programming interface, a tool kit and a processing device for performing the method of configuring via the control of claim 19.

25. A modulated data signal carrying computer executable instructions for performing the method of claim 19.

26. A computer readable medium comprising computer executable instructions for performing the method of claim 19.

27. A computer readable medium comprising computer executable modules having computer executable instructions for automatically configuring products or services via a reusable control in connection with a catalog in a computing system, comprising:
means for specifying a product collection, the variant dimensions of the product collection and a plurality of valid product configurations for the product collection;
means for maintaining a selection criterion of a chosen variant dimension's value; and
means for automatically populating the remaining variant dimensions with valid distinct values based on the current selection criterion.

28. A computer readable medium comprising computer executable modules having computer executable instructions for providing a valid set of choices from a greater body of information based upon one or more selection criteria,
means for exposing a plurality of input portions, an input portion for each distinct value per variant dimension for a record set of all product variants;
means for receiving a selection of a variant value from an input portion;
means for filtering the record set based upon the selection; and
based on the filtering, means for automatically repopulating the remaining input portions with only the valid choices for the selection.
